(19) United States
(12) Patent Application Publication
(10) Pub. No.: US 2019/0039571 A1
(43) Pub. Date: Feb. 7, 2019

(54) VEHICLE DOOR LOCK CONTROL DEVICE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Atsushi SHIMIZU, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/075,374

(22) PCT Filed: Jan. 24, 2017
(86) PCT No.: PCT/JP2017/002207

§ 371 Date: Aug. 3, 2018

(30) Foreign Application Priority Data
Feb. 11, 2016 (JP) 2016-024251

(51) Int. Cl. B60R 25/31; B60R 25/20; E05B 81/04; E05B 81/64

(52) U.S. Cl. CPC B60R 25/31; E05B 81/64; E05B 81/04; B60R 25/20

(57) ABSTRACT

A vehicle door lock control device that includes a communicator that performs communication with a portable communication device that has a wireless communication function, locking of a door of a vehicle being controlled in accordance with communication with the portable communication device; and a processor that is configured to: lock the door in accordance with presence/absence of communication with the portable communication device; acquire information regarding a vicinity of the vehicle; and lock the door based on the information acquired regarding the vicinity of the vehicle.

This application is the U.S. National Phase of PCT/JP2017/002207 filed Jan. 24, 2017, which claims priority to JP 2016-024251 filed Feb. 11, 2016, the entire disclosure of which is incorporated herein by reference.

### BACKGROUND

The present disclosure relates to a vehicle door lock control device that controls the locking and unlocking of a vehicle door in accordance with wireless communication with a portable communication device in the possession of a user.

Conventionally, a system has been widely used in which the door of a vehicle is locked and unlocked without the use of a mechanical key, by performing wireless communication between a portable communication device in the possession of a user and a vehicle door lock control device provided in the vehicle. This system can also be called a keyless entry system, a smart entry system (registered trademark), or the like.

JP 2003-269023A proposes a door lock control device having a configuration in which LF-UHF intercommunication is performed between a portable device and an onboard device, an auto-lock distance switch is provided to allow a user to designate an auto-lock distance at a far distance or a near distance, whereby in the case where the near distance has been designated using this switch, an auto-lock function is executed if LF communication from the onboard device to the portable device is lost, and in the case where the far distance has been designated, the auto-lock function is executed if UHF communication from the portable device to the onboard device is lost.

### SUMMARY

However, with the door lock control device disclosed in JP 2003-269023A, there is a problem in that door locking is not performed until the user in possession of the portable device has moved a predetermined distance or farther from the vehicle (a distance at which wireless communication between the portable device and the onboard device is lost). For this reason, there is a risk that a suspicious person or the like will enter the vehicle before the user has moved the predetermined distance or farther from the vehicle.

An exemplary aspect of the present disclosure provides a vehicle door lock control device that can prevent the entrance of a suspicious person or the like into a vehicle.

A vehicle door lock control device according to the present disclosure includes a communicator that performs communication with a portable communication device that has a wireless communication function, locking of a door of a vehicle being controlled in accordance with communication with the portable communication device; and a processor that is configured to: lock the door in accordance with presence/absence of communication with the portable communication device; acquire information regarding a vicinity of the vehicle; and lock the door based on the information acquired regarding the vicinity of the vehicle.

Also, the vehicle door lock control device according to the present disclosure may have a configuration in which the processor locks the door in a case where communication cannot be performed with the portable communication device.

Also, the vehicle door lock control device according to the present disclosure may have a configuration in which the processor locks the door in a case where a person or an object approaching the vehicle exists.

Also, the vehicle door lock control device according to the present disclosure may have a configuration in which the processor detects opening/closing of the door of the vehicle, and locks the door based on the information regarding the vicinity of the vehicle on a side on which door opening/closing was not detected.

Also, the vehicle door lock control device according to the present disclosure may have a configuration in which execution of lock control on the door by the processor based on the information acquired regarding the vicinity of the vehicle is started after every door of the vehicle is closed based on the detection of the opening/closing of the door of the vehicle.

Also, the vehicle door lock control device according to the present disclosure may have a configuration in which a notification is provided by the processor based on the information acquired regarding the vicinity of the vehicle.

In the vehicle door lock control device of the present disclosure, control for locking the door of the vehicle is performed according to the presence/absence (ability/inability) of wireless communication with the portable communication device in the possession of the user. For example, the vehicle door lock control device locks the door of the vehicle if communication cannot be performed with the portable communication device. Accordingly, if the user in possession of the portable communication device moves away from the vehicle, and communication with the portable communication device can no longer be performed, the door of the vehicle can be automatically locked.

Also, the vehicle door lock control device acquires vehicle vicinity information with use of cameras, sensors, radar devices, or the like, and determines whether or not an abnormality has occurred based on the acquired information. Upon determining that an abnormality has occurred, the vehicle door lock control device locks the door of the vehicle. Accordingly, if it is determined that an abnormality has occurred in the vicinity of the vehicle in the state where the user is moving away from the vehicle and communication can performed with the portable communication device in the possession of the user, the door of the vehicle is automatically locked, thus making it possible to prevent a suspicious person from entering the vehicle.

The abnormality determination made by the vehicle door lock control device can be made by, for example, determining whether or not a person or object approaching the vehicle exists. Accordingly, if a suspicious person or the like is approaching the vehicle while the door of the vehicle is not locked, it is possible to automatically lock the door.

Also, the vehicle door lock control device of the present disclosure detects the opening/closing of the door of the vehicle, and determines whether or not an abnormality has occurred in the vicinity of the vehicle on the side on which door opening/closing has not been performed. Also, the vehicle door lock control device starts to make the abnormality determination after every door of the vehicle has been closed. Accordingly, it is possible to prevent the case where a passenger who is attempting to exit or has exited the vehicle is mistakenly determined to be a suspicious person.

Also, in the vehicle door lock control device of the present disclosure, a notification is given if it is determined that an abnormality has occurred in the vicinity of the vehicle. The notification can be given by a method of outputting audio, lighting a lamp, or the like, or can be given by a method such as transmitting a message to a mobile phone in the possession of another passenger, a server device at an alarm company, or the like. Accordingly, it is possible to prevent theft of the vehicle, for example.

According to the present disclosure, by employing a configuration in which the door is locked if it is determined that an abnormality occurred in the vicinity of the vehicle, it is possible to prevent a suspicious person or the like from entering the vehicle.

### BRIEF DESCRIPTION OF THE DRAWINGS

FIG. 1 is a schematic diagram for illustrating an overview of a vehicle door lock system according to an embodiment of the present disclosure.

FIG. 2 is a block diagram showing a configuration of a vehicle door lock control device according to the embodiment.

FIG. 3 is a flowchart showing a procedure of door lock control processing performed by a body ECU.

FIG. 4 is a flowchart showing a procedure of vehicle vicinity monitoring processing performed by the body ECU.

FIG. 5 is a schematic diagram for illustrating an overview of a vehicle door lock system according to a second variation.

### DETAILED DESCRIPTION OF EMBODIMENTS

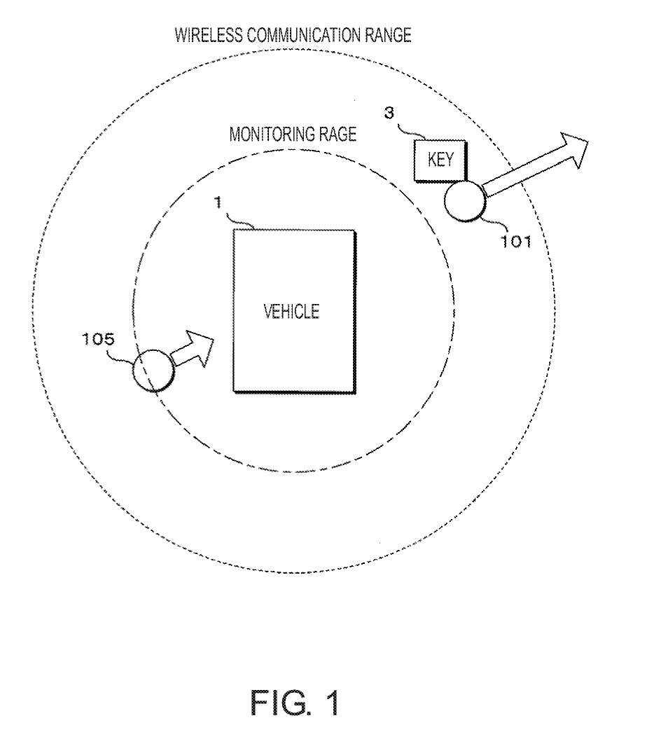

FIG. 1 is a schematic diagram for illustrating an overview of a vehicle door lock system according to an embodiment of the present disclosure. The vehicle door lock system according to the present embodiment has a configuration in which wireless communication is performed between a wireless communication device disposed in a vehicle 1 and a wireless key 3 in the possession of a user 101, and a body ECU disposed in the vehicle 1 performs door lock/unlock control based on the ability/inability, content, or the like of the wireless communication. The vehicle door lock system according to the present embodiment can also be called a keyless entry system, a smart entry system, or the like.

The vehicle door lock system according to the present embodiment has a function of automatically locking the doors of the vehicle 1 in the case where the user 101 in possession of the key 3 exits the vehicle 1 and furthermore moves away from the vehicle 1 and moves out of the wireless communication range of the vehicle 1 and the key 3 (indicated by a dashed line circle in FIG. 1). The vehicle door lock system according to the present embodiment also has a function of monitoring the vicinity of the vehicle 1 (the monitoring range is indicated by a dashed-dotted line circle in FIG. 1) with use of a camera, a radar device, or the like until the user 101 who exited the vehicle 1 moves out of the wireless communication range, and automatically locking the doors of the vehicle 1 in the case of detecting an abnormality such as the presence of a suspicious person 105 in the vicinity of the vehicle 1.

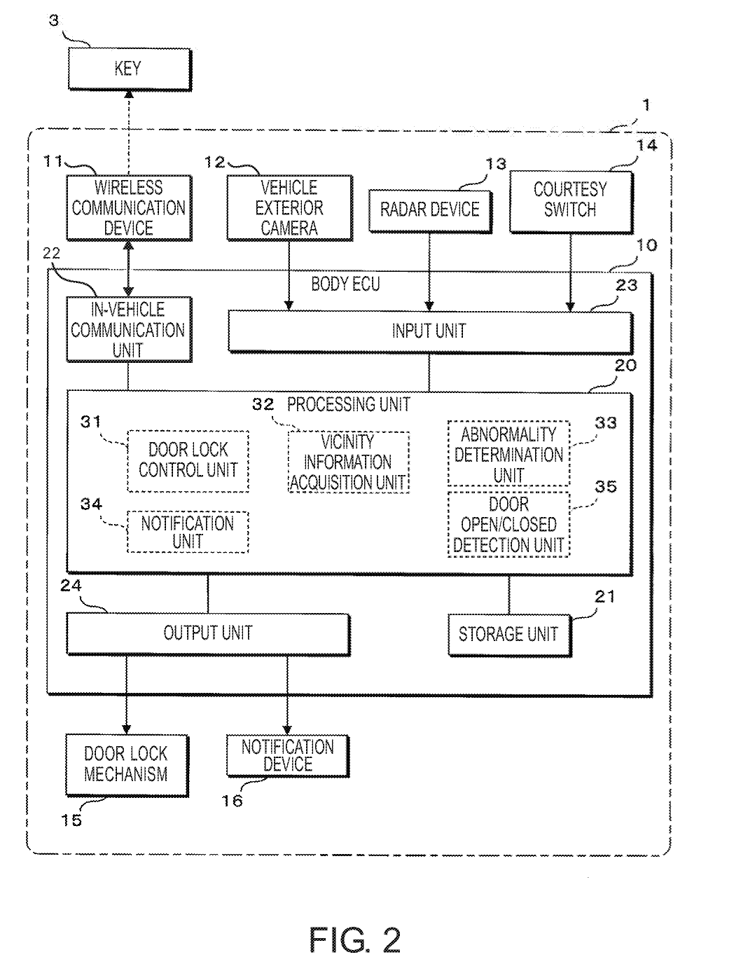

FIG. 2 is a block diagram showing the configuration of a vehicle door lock control device according to the present embodiment. The vehicle door lock control device according to the present embodiment is a device that is disposed in the vehicle 1 and performs lock/unlock control with respect to the doors of the vehicle 1 in accordance with wireless communication with the key 3, and is realized by a body ECU (Electronic Control Unit) 10 for example. The body ECU 10 performs door lock/unlock control by communicating with the key 3 in the possession of the user via a wireless communication device 11 disposed in the vehicle 1, and outputting a control signal to door lock mechanisms 15 based on the ability/inability, content, or the like of communication with the key 3.

Also, in the present embodiment, vehicle exterior cameras 12 and radar devices 13 are disposed in the vehicle 1 as devices for monitoring the vicinity. The body ECU 10 determines whether or not an abnormality has occurred in the vicinity of the vehicle 1 based on information input from the vehicle exterior cameras 12 and the radar devices 13. In the case of determining that an abnormality occurred, the body ECU 10 can lock the doors by outputting control signals to the door lock mechanisms 15, and can also report the abnormality by giving a reporting command to a notification device 16. The body ECU 10 also receives an input of the states of courtesy switches 14 provided in the doors of the vehicle 1, and can detect the open/closed states of the doors based on the input states.

The body ECU 10 according to the present embodiment is configured to include a processing unit 20, a storage unit 21, an in-vehicle communication unit 22 (i.e., communicator), an input unit 23, an output unit 24, and the like. The processing unit 20 is constituted using an arithmetic processing device such as a CPU (Central Processing Unit) or an MPU (Micro-Processing Unit). The processing unit 20 performs various types of arithmetic processing, control processing, and the like related to vehicle 1 door locking and unlocking by reading out and executing programs stored in the storage unit 21 or a ROM (Read Only Memory) that is not shown.

The storage unit 21 is constituted using a nonvolatile memory device such as a flash memory or an EEPROM (Electrically Erasable Programmable Read Only Memory). The storage unit 21 stores programs executed by the processing unit 20, data necessary for the execution of the programs, and the like. In the present embodiment, the storage unit 21 stores authentication information for determining whether or not the key 3 is an authorized key, for example.

The in-vehicle communication unit 22 can perform communication with other onboard devices via an in-vehicle network such as a CAN (Controller Area Network). In the present embodiment, the in-vehicle communication unit 22 performs communication with the wireless communication device 11 via the in-vehicle network. The in-vehicle communication unit 22 transmits transmission information received from the processing unit 20 to the wireless communication device 11, and passes information received from the wireless communication device 11 to the processing unit 20. The wireless communication device 11 can perform wireless communication with the key 3 by transmitting LF (Low Frequency) band wireless signals to the key 3 and receiving UHF (Ultra High Frequency) band wireless signals transmitted by the key 3. Also, the wireless communication device 11 can perform communication with other onboard devices via the in-vehicle network in the vehicle 1, and performs communication with the body ECU 10 in the present embodiment. Accordingly, the body ECU 10 can perform communication with the key 3 via the wireless communication device 11.

The input unit 23 is connected to information input devices such as the vehicle exterior cameras 12, the radar devices 13, and the courtesy switches 14 via signal lines, and accepts digital or analog signals from these information input devices. The input unit 23 samples the input signals to obtain digital information, and passes the digital information to the processing unit 20. The vehicle exterior cameras 12 are provided at the front, rear, left, and right of the vehicle 1 for example, and can capture images of the vicinity of the vehicle 1 over approximately 360°. The vehicle exterior cameras 12 input the captured images to the body ECU 10. The radar devices 13 are devices that measure the distance to a subject by emitting radio waves and detecting reflected waves. The radar devices 13 are provided at the front, rear, left, and right of the vehicle 1 for example, and measure the distance to a subject such as a person or an object in the vicinity of the vehicle 1. In the present embodiment, the imaging range of the vehicle exterior cameras 12 and the measurement range of the radar devices 13 are the monitoring range indicated by a dashed-dotted line in FIG. 1. The courtesy switches 14 are switches for controlling the lighting and extinguishing of courtesy lamps provided in the doors of the vehicle 1, and input, to the ECU 10, signals indicating whether the doors are in the open state or the closed state.

The output unit 24 is connected to control-target devices such as the door lock mechanisms 15 and the notification device 16 via signal lines, and outputs control signals to these control-target devices in accordance with commands from the processing unit 20. One door lock mechanism 15 is provided for each door of the vehicle 1, and is configured to include a mechanical mechanism for locking the door, and a motor, an actuator, or the like for operating the mechanical mechanism The door lock mechanisms 15 perform door locking and unlocking in accordance with operation commands given by the ECU 10. The notification device 16 may be a horn, a lamp, or the like of the vehicle 1, and reports that an abnormality occurred by, for example, outputting an alarm or blinking the lamp in a predetermined pattern in accordance with an operation command given by the body ECU 10.

Note that in the configuration of the present embodiment, the devices that input signals to the ECU 10 and the devices that receive signals from the ECU 10 are individually connected to the ECU 10 via signals lines, but there is no limitation to this. One or more of these devices may be configured to perform communication with the ECU 10 via the in-vehicle network of the vehicle 1, for example.

Also, in the processing unit 20 of the ECU 10 according to the present embodiment, a door lock control unit 31, a vicinity information acquisition unit 32, an abnormality determination unit 33, a notification unit 34, a door open/closed detection unit 35, and the like are realized as software function blocks by executing programs stored in the storage unit 21. The door lock control unit 31 performs processing for outputting control signals for performing vehicle 1 door locking and unlocking to the door lock mechanisms 15 in accordance with the results of wireless communication performed with the key 3 via the wireless communication device 11. For example, the door lock control unit 31 performs processing for automatically locking the doors of the vehicle 1 if the ability to perform wireless communication with the key 3 in the possession of the user 101 is lost after exiting the vehicle 1. As another example, in the case where, for example, the user 101 in possession of the key 3 has moved near the vehicle 1 or performed an operation on an unlocking operation portion provided in a door or the like, the door lock control unit 31 performs communication with the key 3 via the wireless communication device 11, performs authentication processing or the like, and performs processing for unlocking a door of the vehicle 1 if it is determined that the key 3 is an authorized key. Also, the door lock control unit 31 according to the present embodiment performs processing for automatically locking the doors of the vehicle 1 if the abnormality determination unit 33 determined that an abnormality occurred.

The vicinity information acquisition unit 32 performs processing for acquiring images captured by the vehicle exterior cameras 12, distances measured by the radar devices 13, and the like as vicinity information, and storing the acquired vicinity information in the storage unit 21, a RAM (Random Access Memory) that is not shown, or the like. Note that the stored vicinity information may be deleted after a predetermined time has elapsed, for example.

The abnormality determination unit 33 determines whether or not an abnormality has occurred in the vicinity of the vehicle 1 based on the stored vicinity information that was acquired by the vicinity information acquisition unit 32. In the present embodiment, based on an image captured by one of the vehicle exterior cameras 12, the abnormality determination unit 33 recognizes, as an authorized user, a person included in an image captured when a door of the vehicle 1 was closed, and if a person other than the authorized user is thereafter detected in a captured image, the abnormality determination unit 33 sets that person as a suspicious person candidate. If it is determined, based on an image captured thereafter, that the suspicious person candidate has moved even closer to the vehicle 1, the abnormality determination unit 33 determines that the person is a suspicious person, and determines that an abnormality has occurred.

Also, in the present embodiment, the abnormality determination unit 33 determines whether a suspicious person approaching the vehicle 1 exists by determining, based on distance information obtained by the radar devices 13, whether or not a person, an object, or the like approaching the vehicle 1 exists. At this time, the abnormality determination unit 33 may give consideration to the movement speed of the approaching person, object, or the like when making this determination. If a suspicious person approaching the vehicle 1 exists, the abnormality determination unit 33 determines that an abnormality has occurred. Note that the abnormality determination unit 33 may use a combination of the vehicle exterior cameras 12 and the radar devices 13, and a configuration is possible in which, if a person is determined to be a suspicious person candidate based on captured images from the vehicle exterior cameras 12 for example, the abnormality determination unit 33 obtains distances measured by the radar devices 13, and determines that an abnormality has occurred if the person is approaching the vehicle 1.

If the abnormality determination unit 33 has determined that an abnormality occurred, the notification unit 34 outputs an operation command to the notification device 16, and thus a notification is performed by outputting an alarm, blinking a lamp, or the like. Note that in the present embodiment, the abnormality is notified using the notification device 16, which is a horn, a lamp, or the like of the vehicle 1, but there is no limitation to this, and a configuration is possible in which the abnormality is notified to a device outside the vehicle 1, such as a mobile phone in the possession of the user 101 or a server device of an alarm company, via a mobile phone network, a wireless LAN (Local Area Network), or the like.

The door open/closed detection unit 35 performs processing for determining whether or not the user has exited the vehicle 1 by detecting the opening and closing of doors of the vehicle 1 based on signals received from the courtesy switches 14. For example, if a door of the vehicle 1 has changed from the closed state to the open state, and then furthermore changed from the open state to the closed state, the door open/closed detection unit 35 determines that the user has exited the vehicle 1. Note that a configuration is possible in which the exiting of the user is determined by also using the result of detection of whether or not the user is sitting by sitting sensors provided in seats of the vehicle 1. In the present embodiment, the processing for acquisition of vicinity information performed by the vicinity information acquisition unit 32 and for abnormality detection performed by the abnormality determination unit 33 is started if it is detected that the user has exited the vehicle 1 and that all of the doors are closed.

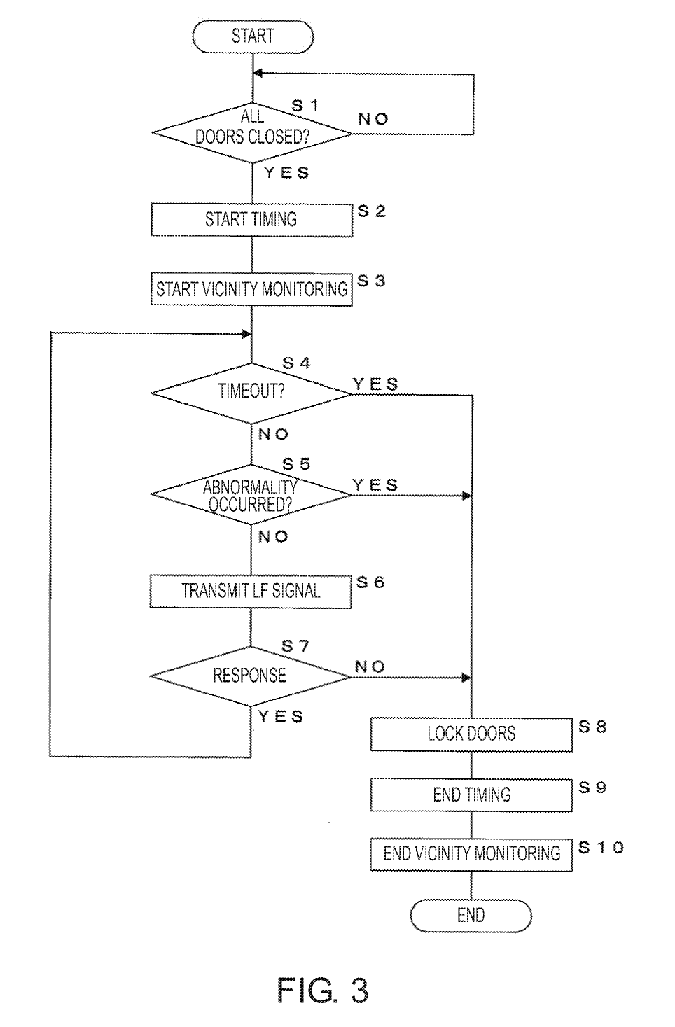

FIG. 3 is a flowchart showing a procedure of door lock control processing performed by the body ECU 10. Note that this processing is performed after the vehicle 1 has been stopped, and the door open/closed detection unit 35 has thereafter detected that at least one door has entered the open state. The door open/closed detection unit 35 of the processing unit 20 of the body ECU 10 determines, based on information input from the courtesy switches 14, whether or not all of the doors of the vehicle 1 have entered the closed state (step S1). If at least one door of the vehicle 1 is in the open state (S1: NO), the processing unit 20 waits until all of the doors have entered the closed state. If all of the doors have entered the closed state (S1: YES), the processing unit 20 starts the timing of a timeout time with use of an internal timer function or the like (step S2). Also, the processing unit 20 starts vehicle 1 vicinity monitor processing, that is to say, starts processing for the acquisition of vicinity information by the vicinity information acquisition unit 32 and abnormality determination performed by the abnormality determination unit 33 (step S3).

Next, the processing unit 20 determines whether or not the time being counted has reached the predetermined timeout time (step S4). Note that the body ECU 10 stores a value of approximately several tens of seconds to several minutes for example in the storage unit 21 as the timeout time, and reads out this value when making the determination in step S4. If the time being counted has reached the timeout time (S4: YES), the door lock control unit 31 of the processing unit 20 locks the doors of the vehicle 1 by outputting a control signal to the door lock mechanisms 15 (step S8). Thereafter, the processing unit 20 ends the timing related to the timeout time (step S9), ends the vehicle 1 vicinity monitoring processing (step S10), and ends the door lock control processing.

If the time being counted has not reached the timeout time (S4: NO), the processing unit 20 checks whether or not the abnormality determination unit 33 has determined that an abnormality occurred in the vehicle vicinity monitoring processing (step S5). If it was determined that an abnormality occurred (S5: YES), the door lock control unit 31 of the processing unit 20 locks the doors of the vehicle 1 by outputting a control signal to the door lock mechanisms 15 (step S8). Thereafter, the processing unit 20 ends the timing related to the timeout time (step S9), ends the vehicle 1 vicinity monitoring processing (step S10), and ends the door lock control processing.

If it was determined that an abnormality has not occurred in the vehicle vicinity monitoring processing (S5: NO), the processing unit 20 transmits an LF signal to the key 3 by giving an operation command to the wireless communication device 11 (step S6). The processing unit 20 determines whether or not the wireless communication device 11 received a response to the LF signal by a UHF signal from the key 3 (step S7). If a response was received from the key 3 (S7: YES), the processing unit 20 returns the processing to step S4. If a response has not been received from the key 3 (S7: NO), the door lock control unit 31 of the processing unit 20 locks the doors of the vehicle 1 by outputting a control signal to the door lock mechanisms 15 (step S8). Thereafter, the processing unit 20 ends the timing related to the timeout time (step S9), ends the vehicle 1 vicinity monitoring processing (step S10), and ends the door lock control processing.

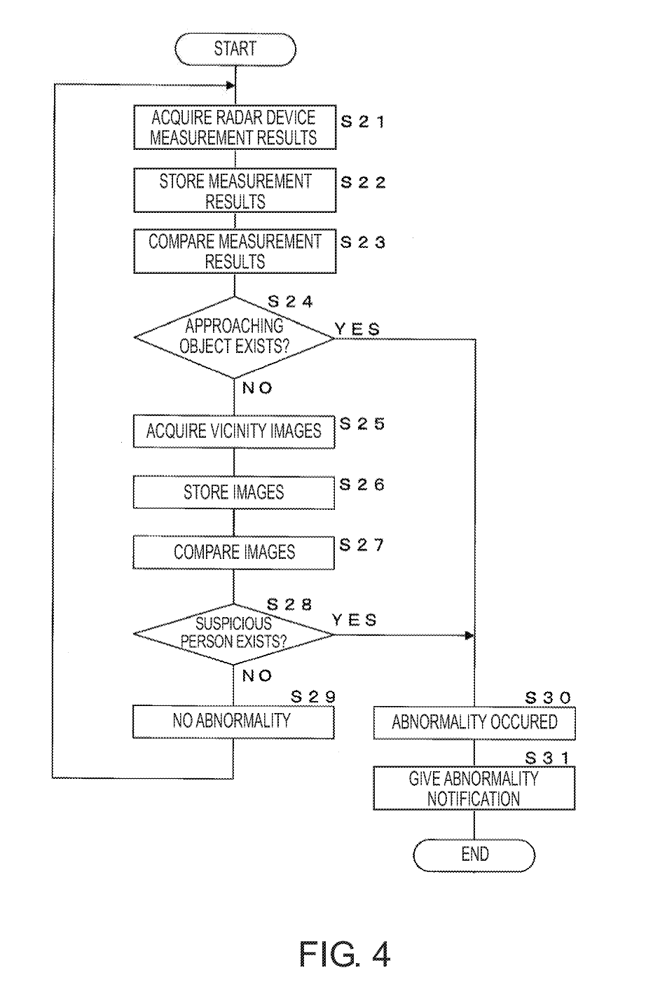

FIG. 4 is a flowchart showing a procedure of vehicle vicinity monitoring processing performed by the body ECU 10. Note that this processing is started if the door lock control processing shown in FIG. 3 has reached step S3, is performed in parallel with this door lock control processing, and is ended if the door lock control processing has reached step S10. The vicinity information acquisition unit 32 of the processing unit 20 of the body ECU 10 acquires the results of measurement of the distance to the subject by the radar devices 13 by the acquisition and sampling of signals from the radar devices 13 that are input to the input unit 23 (step S21), and stores the acquired measurement results in the storage unit 21, the RAM, or the like (step S22). The abnormality determination unit 33 of the processing unit 20 compares measurement results stored in the storage unit 21, the RAM, or the like (step S23), and determines whether or not an object approaching the vehicle 1 exists (step S24).

If an object approaching the vehicle 1 does not exist (S24: NO), the vicinity information acquisition unit 32 of the processing unit 20 acquires images of the vicinity of the vehicle 1 input from the vehicle exterior cameras 12 (step S25), and stores the acquired images in the storage unit 21, the RAM, or the like (step S26). The abnormality determination unit 33 of the processing unit 20 compares the images stored in the storage unit 21, the RAM, or the like (step S27), and determines whether or not a suspicious person exists in the vicinity of the vehicle 1 (step S28). If a suspicious person does not exist (S28: NO), the abnormality determination unit 33 determines that an abnormality has not occurred in the vicinity of the vehicle 1 (step S29), and returns the processing to step S21.

If an object is approaching the vehicle 1 in step S24 (S24: YES), or if a suspicious person exists in the vicinity of the vehicle 1 in step S28 (S28: YES), the abnormality determination unit 33 determines that an abnormality has occurred in the vicinity of the vehicle 1 (step S30). The notification unit 34 of the processing unit 20 outputs an operation command to the notification device 16 so as to give a notification of the abnormality by outputting an alarm, blinking a lamp, or the like (step S31), and then ends this processing.

With the vehicle door lock system according to the present embodiment having the above configuration, the body ECU 10 performs vehicle 1 door lock/unlock control in accordance with whether or not communication is performed between the key 3 in the possession of the user and the wireless communication device 11. If communication cannot be performed with the key 3, the body ECU 10 performs control for locking the doors of the vehicle 1, thus making it possible to automatically lock the doors if the user in possession of the key 3 moves away from the vehicle 1.

Also, the body ECU 10 acquires vehicle vicinity information obtained by the vehicle exterior cameras 12 and the radar devices 13, and determines whether or not an abnormality has occurred in the vicinity of the vehicle 1 based on the acquired information. Upon determining that an abnormality has occurred, the body ECU 10 performs control for locking the doors of the vehicle 1. Accordingly, if it is determined that an abnormality has occurred in the vicinity of the vehicle 1 in the state where the user is moving away from the vehicle 1 and communication can performed between the key 3 in the possession of the user and the wireless communication device 11 of the vehicle 1, the doors of the vehicle 1 are automatically locked, thus making it possible to prevent a suspicious person from entering the vehicle 1.

Also, the body ECU 10 determines whether or not an abnormality has occurred in the vicinity of the vehicle 1 by determining whether or not a person or an object approaching the vehicle 1 exists based on vehicle vicinity information acquired by the vehicle exterior cameras 12 and the radar devices 13.

Accordingly, if a suspicious person or the like approaches the vehicle 1 while the doors of the vehicle 1 are unlocked, it is possible to automatically lock the doors. Also, the body ECU 10 detects the opening and closing of the doors of the vehicle 1 based on input signals from the courtesy switches 14, and starts vehicle vicinity monitoring processing after all of the doors of the vehicle 1 have been closed. Accordingly, it is possible to prevent the case where an authorized user who is attempting to exit or has exited the vehicle 1 is mistakenly determined to be a suspicious person. Also, if the body ECU 10 determines that an abnormality has occurred in the vicinity of the vehicle 1, the notification device 16 gives a notification by outputting an alarm, blinking a lamp, or the like. Accordingly, it is possible to prevent theft of the vehicle 1, for example.

Note that although the vicinity of the vehicle is monitored with use of the vehicle exterior cameras 12 and the radar devices 13 in the configuration of the present embodiment, there is no limitation to this. For example, a configuration is possible in which the vicinity of the vehicle is monitored with use of only either the vehicle exterior cameras 12 or the radar devices 13, and a configuration is possible in which monitoring is performed with use of a device other than the vehicle exterior cameras 12 and the radar devices 13. Also, the abnormality determination method performed using the vehicle exterior cameras 12 and the radar devices 13 is not limited to the method described above, and it is possible to use various other types of methods. Also, although the body ECU 10 is configured to give an abnormality notification using the notification device 16 if it is determined that an abnormality has occurred in the vicinity of the vehicle 1, there is no limitation to this, and a configuration is possible in which a notification is not given.

Also, although the wireless communication device 11 and the body ECU 10 are separate devices in the present embodiment, there is no limitation to this, and they may be realized as a single device that has the functionality of the wireless communication device 11 and the functionality of the body ECU 10. Similarly, the body ECU 10 and the notification device 16 may be realized as a single device. The processing, functions, and the like described as being performed by multiple devices in the present embodiment may be integrated and realized in a single device. Also, the processing, functions, and the like described as being performed by a single device in the present embodiment may be realized by cooperation between multiple devices.

### First variation

In the configuration of the embodiment described above, vehicle vicinity monitoring processing, which includes the acquisition of the vehicle vicinity information, the determination of whether an abnormality has occurred, and the like, is started if all of the doors of the vehicle 1 have entered the closed state, but there is no limitation to this. The timing of the start of the vehicle vicinity monitoring processing may be a timing other than when all of the doors have entered the closed state. For example, in the vehicle door lock system according to a first variation, the monitoring range of the vehicle vicinity monitoring processing is set smaller than the wireless communication range of the wireless communication device 11 of the vehicle 1 and the key 3 in the possession of the user 101 as shown in FIG. 1. The body ECU 10 of the first variation starts the vehicle vicinity monitoring processing in the case where, after all of the doors of the vehicle 1 have been closed, it is detected by the vehicle exterior cameras 12 and the radar devices 13 that the user 101 in possession of the key 3 has moved out of the monitoring range. Accordingly, it is possible to prevent the case where the user 101 who has exited the vehicle 1 is mistakenly determined to be the suspicious person 105.

### Second variation

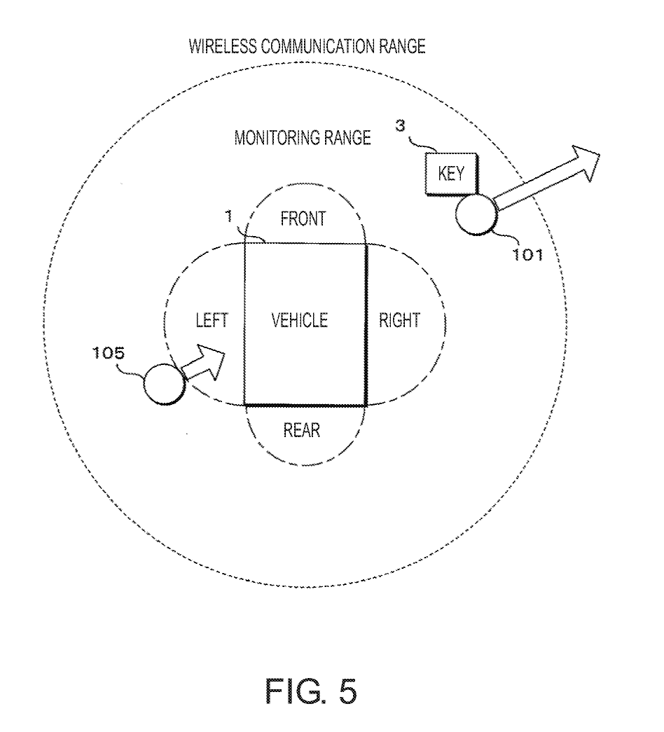

FIG. 5 is a schematic diagram for illustrating an overview of the vehicle door lock system according to a second variation. In the vehicle door lock system according to the second variation, the range of the vehicle vicinity that is monitored using the vehicle exterior cameras 12 and the radar devices 13 is divided into four ranges on the front, rear left, and right sides of the vehicle 1. The body ECU 10 of the second variation stores information indicating which of the doors are opened after the vehicle 1 has stopped, for example. If all of the doors have been closed, the body ECU 10 sets the monitoring range on the side corresponding to the opened door as a range that is not to be monitored, and performs vehicle vicinity monitoring processing with respect to only the monitoring ranges on the sides corresponding to the doors that were not opened.

For example, if a door on the right side is opened, the user 101 exits the vehicle 1, and then that door is closed, the body ECU 10 sets the right side of the vehicle 1 as a range that is not to be monitored, and performs vehicle vicinity monitoring processing with respect to the monitoring ranges on the front, rear, and left sides of the vehicle 1. Accordingly, with the vehicle door lock system of the second variation, it is possible to prevent the case where the user 101 who exited the vehicle 1 is mistakenly determined to the suspicious person 105.

1. A vehicle door lock control device comprising:
a communicator that performs communication with a portable communication device that has a wireless communication function, locking of a door of a vehicle being controlled in accordance with communication with the portable communication device; and
a processor that is configured to:
lock the door in accordance with presence/absence of communication with the portable communication device;
acquire information regarding a vicinity of the vehicle; and
lock the door based on the information acquired regarding the vicinity of the vehicle.

2. The vehicle door lock control device according to claim 1, wherein the processor locks the door in a case where communication cannot be performed with the portable communication device.

3. The vehicle door lock control device according to claim 1, wherein the processor locks the door in a case where a person or an object approaching the vehicle exists.

4. The vehicle door lock control device according to claim 1, wherein the processor:
detects opening/closing of the door of the vehicle, and
locks the door based on the information regarding the vicinity of the vehicle on a side on which door opening/closing was not detected.

5. The vehicle door lock control device according to claim 4, wherein execution of lock control on the door by the processor based on the information acquired regarding the vicinity of the vehicle is started after every door of the vehicle is closed based on the detection of the opening/closing of the door of the vehicle.

6. The vehicle door lock control device according to claim 1, wherein a notification is provided by the processor based on the information acquired regarding the vicinity of the vehicle.
